(19) United States
(12) Patent Application Publication
(10) Pub. No.: US 2020/0118304 A1
(43) Pub. Date: Apr. 16, 2020

(54) IMAGE PROCESSING APPARATUS, IMAGE PROCESSING METHOD, AND RECORDING MEDIUM

(71) Applicant: CASIO COMPUTER CO., LTD., Tokyo (JP)

(72) Inventor: Takeshi SATO, Tokyo (JP)

(21) Appl. No.: 16/598,891

(22) Filed: Oct. 10, 2019

(30) Foreign Application Priority Data
Oct. 11, 2018 (JP) 2018-192562

(51) Int. Cl. G06T 11/00; G06T 7/90; G06T 7/00

(52) U.S. Cl. CPC G06T 11/001; G06T 7/90; G06T 2207/30041; G06T 2207/30088; G06T 7/0012

(57) ABSTRACT

An imaging apparatus includes a correction execution unit, a reduction pixel specification unit, and a correction control unit. The correction execution unit performs a correction process on a pixel region of a skin color in an image. The reduction pixel specification unit acquires a pixel region whose saturation is different from that of a surrounding pixel in the image. The correction control unit controls the pixel region acquired by the reduction pixel specification unit to reduce the correction process by the correction execution unit.

This application is based on and claims the benefit of priority from Japanese Patent Application No. 2018-192562, filed on 11 Oct. 2018, the content of which is incorporated herein by reference.

### BACKGROUND OF THE INVENTION

### Field of the Invention

The present invention relates to an image processing apparatus, an image processing method, and a recording medium.

### Related Art

Conventionally, as described in JP 2012-124715 A, there has been a known technology for detecting a region of a skin color of a face in an image and performing a skin color correction process on the region of the skin color.

### SUMMARY OF THE INVENTION

An image processing apparatus of an aspect of the invention includes a processor, in which the processor acquires a pixel region of a first pixel and a pixel region of a second pixel whose saturation is higher than a saturation of the first pixel in an image region of a skin color in an image,

performs, a smoothing process on the pixel region of the skin color in the image so that an intensity of the smoothing process of the skin color luminance component of the pixel region of the second pixel is less than the intensity of the smoothing process of the skin color luminance component of the pixel region of the first pixel; and,

a memory stored the image having the smoothed pixel region.

In addition, an image processing method of an aspect of the invention includes an acquisition step of acquiring a pixel region of a first pixel and a pixel region of a second pixel whose saturation is higher than a saturation of the first pixel in an image region of a skin color in an image;

a processing step of performing a smoothing process on the pixel region of the skin color in the image so that an intensity of the smoothing process of the skin color luminance component of the pixel region of the second pixel is less than the intensity of the smoothing process of the skin color luminance component of the pixel region of the first pixel; and,

a storing step of the image having the smoothed pixel region to a memory.

In addition, a recording medium of an aspect of the invention is a recording medium on which a program readable by a computer included in an image processing apparatus is recorded, the recording medium causing the computer to function as an acquisition mechanism that acquires a pixel region of a first pixel and a pixel region of a second pixel whose saturation is higher than a saturation of the first pixel in an image region of a skin color in an image;

a processing mechanism that performs, a smoothing process on the pixel region of the skin color in the image so that an intensity of the smoothing process of the skin color luminance component of the pixel region of the second pixel is less than the intensity of the smoothing process of the skin color luminance component of the pixel region of the first pixel; and,

a storing mechanism that stores to the image having the smoothed pixel region to a memory.

### BRIEF DESCRIPTION OF THE DRAWINGS

FIG. 1 is a block diagram illustrating a hardware configuration of an imaging apparatus according to an embodiment of an image processing apparatus of the invention. FIG. 2 is a schematic diagram for description of a course of a skin image correction process performed by the imaging apparatus according to the embodiment of the image processing apparatus of the invention. FIG. 3 is a schematic diagram for description of image synthesis in the skin image correction process performed by the imaging apparatus according to the embodiment of the image processing apparatus of the invention. FIG. 4 is a functional block diagram illustrating a functional configuration for executing the skin image correction process in a functional configuration of the imaging apparatus of FIG. 1. FIG. 5 is a flowchart for description of a flow of the skin image correction process executed by the imaging apparatus of FIG. 1 having the functional configuration of FIG. 4.

### DETAILED DESCRIPTION OF THE INVENTION

Hereinafter, an embodiment of the invention will be described with reference to drawings.

### [Hardware Configuration]

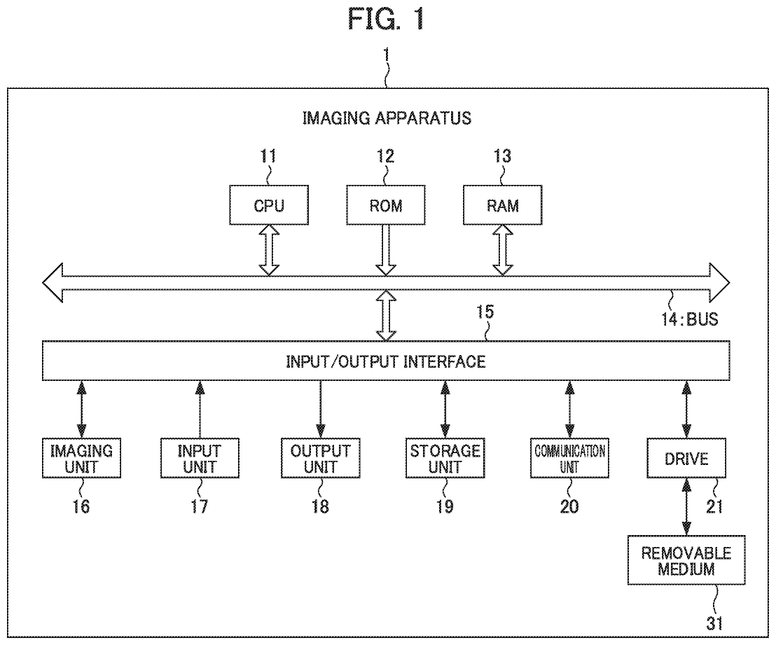

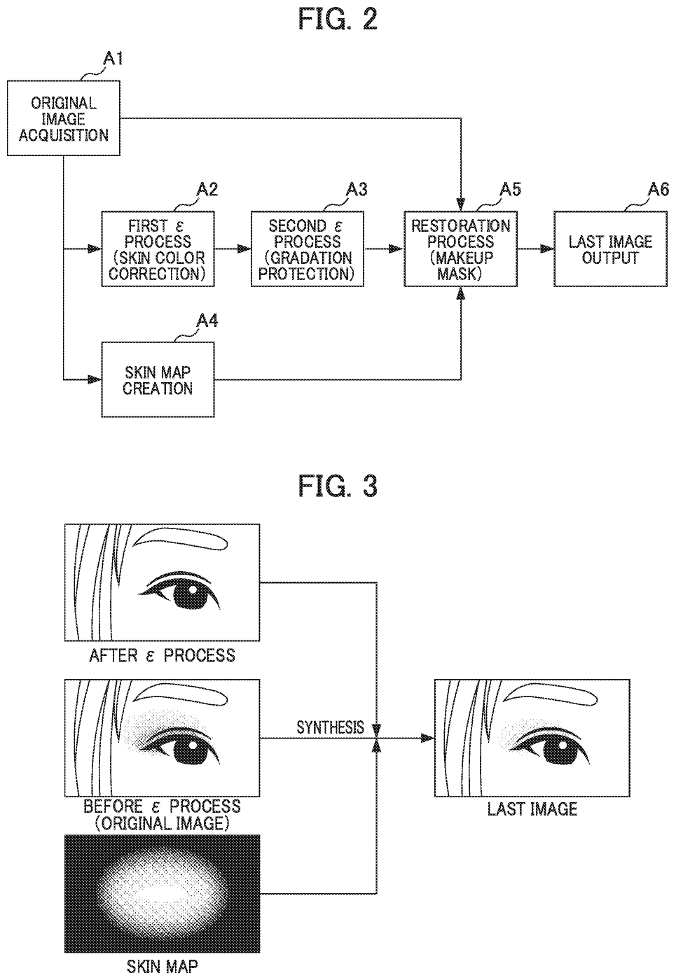

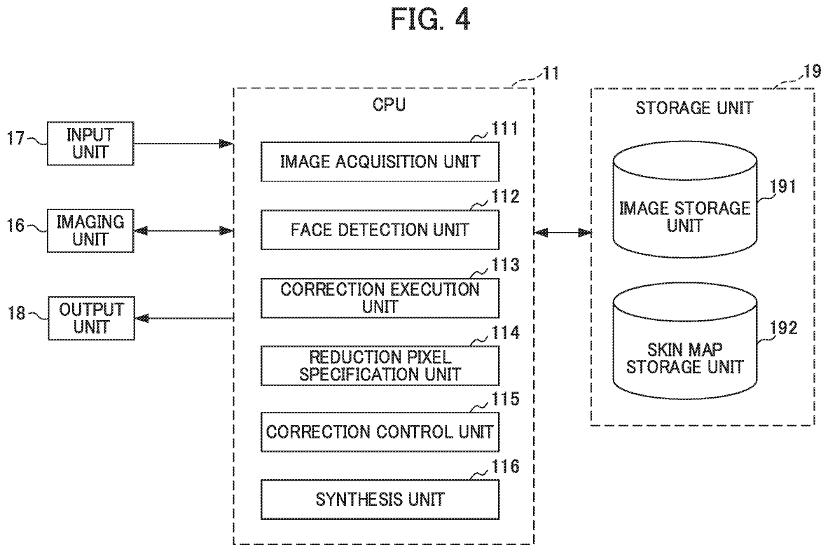

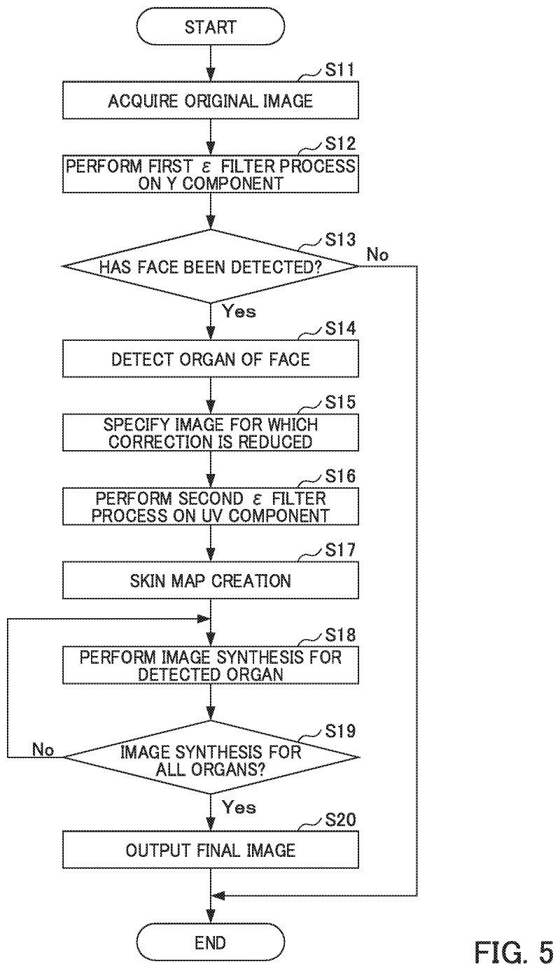

FIG. 1 is a block diagram illustrating a hardware configuration of an imaging apparatus 1 according to an embodiment of an image processing apparatus of the invention. For example, the imaging apparatus 1 is configured as a digital camera having an image processing function.

As illustrated in FIG. 1, the imaging apparatus 1 includes a central processing unit (CPU) 11, a read only memory (ROM) 12, a random access memory (RAM) 13, a bus 14, an input/output interface 15, an imaging unit 16, an input unit 17, an output unit 18, a storage unit 19, a communication unit 20, and a drive 21.

The CPU 11 is a processor that executes various processes according to a program recorded in the ROM 12 or a program loaded in the RAM 13 from the storage unit 19.

The RAM 13 appropriately stores data, etc. necessary for the CPU 11 to execute various processes.

The CPU 11, ROM 12, and RAM 13 are connected to each other via the bus 14. In addition, the input/output interface 15 is connected to the bus 14. The imaging unit 16, the input unit 17, the output unit 18, the storage unit 19, the communication unit 20, and the drive 21 are connected to the input/output interface 15.

Although not illustrated, the imaging unit 16 includes an optical lens unit and an image sensor.

The optical lens unit includes a lens that collects light, for example, a focus lens or a zoom lens, to capture an image of a subject. The focus lens is a lens that forms a subject image on a light receiving surface of the image sensor. The zoom lens is a lens that freely changes a focal length within a certain range. The optical lens unit further includes a peripheral circuit for adjusting setting parameters such as focus, exposure, and white balance as necessary.

The image sensor includes a photoelectric conversion element, an analog front end (AFE), etc. The photoelectric conversion element includes, for example, a complementary metal oxide semiconductor (CMOS) type photoelectric conversion element, etc. A subject image is incident on the photoelectric conversion element from the optical lens unit. Therefore, the photoelectric conversion element photo-electrically converts (captures) the subject image, accumulates an image signal for a predetermined time, and successively supplies the accumulated image signal as an analog signal to the AFE. The AFE performs various signal processing such as analog/digital (A/D) conversion processing on the analog image signal. Through various signal processing, a digital signal is generated and output as an output signal of the imaging unit 16. Such an output signal of the imaging unit 16 is appropriately supplied to the CPU 11 or an image processing unit (not illustrated) as a captured image.

The input unit 17 includes various buttons, etc., and inputs various types of information according to an instruction operation of a user. The output unit 18 includes a display, a speaker, etc., and outputs an images and sound. The storage unit 19 includes a hard disk, a dynamic random access memory (DRAM), etc., and stores various images. The communication unit 20 controls communication performed with another device (not illustrated) via a network including the Internet.

A removable medium 31 including a magnetic disk, an optical disc, a magneto-optical disk, a semiconductor memory, etc. is appropriately attached to the drive 21. A program read from the removable medium 31 by the drive 21 is installed in the storage unit 19 as necessary. In addition, the removable medium 31 can store various data such as images stored in the storage unit 19 in the same manner as the storage unit 19.

The imaging apparatus 1 configured as described above performs the skin image correction process. Here, the skin image correction process corresponds to a series of processes in which a correction process is performed on an image including an object with the skin and a control operation is performed to reduce the correction process for a predetermined region. Specifically, in the skin image correction process, the imaging apparatus 1 performs the correction process on a pixel region of a skin color in the image. In addition, the imaging apparatus 1 acquires a pixel region having a saturation different from that of surrounding pixels in the image. Furthermore, the imaging apparatus 1 performs a control operation to reduce the correction process for the acquired pixel region.

As described above, the imaging apparatus 1 can perform more appropriate correction in image processing for an image including skin by performing the control operation to reduce the correction process for a part of the region. For example, by reducing correction, it is possible to correct an expression of texture of the skin while retaining an effect of makeup and an expression of an original clear skin. That is, it is possible to perform image processing in which such two expressions are compatible. Accordingly, the imaging apparatus 1 can solve a problem that when the correction process is uniformly performed as in a general technology, a region of a color partially different from the skin color (for example, a region to which makeup is applied or a region having the clear skin) becomes inconspicuous due to the correction process.

### [Skin Image Correction Process]

Next, a description will be given of the skin image correction process with reference to FIGS. 2 and 3. FIG. 2 is a schematic diagram for description of a course of the skin image correction process. In addition, FIG. 3 is a schematic diagram for description of image synthesis in the skin image correction process.

### <A1: Acquisition of Original Image>

First, as illustrated in FIG. 2, the imaging apparatus 1 acquires an image (hereinafter referred to as an “original image”) that is a target of the skin image correction process. A type of image to which the original image corresponds is not particularly limited. Here, as the original image, it is presumed that an image including a human face and expressed in YUV as an image parameter is used as the original image. Here, in YUV, an image is expressed based on digital values indicated by a luminance component signal Y, a blue component difference signal Cb, and a red component difference signal Cr.

### <A2: First ε Process (Skin Color Correction)>

Next, the imaging apparatus 1 performs a smoothing process using an ε filter (hereinafter referred to as an “ε process”) on the original image. In the smoothing process using the ε filter, small signal noise is removed from the acquired original image while maintaining a sharp change in luminance value in the image. In this way, a flat image can be generated by removing small irregularities while leaving an edge. The smoothing process using the ε filter may be performed on pixels corresponding to a skin color region of the original image, or may be performed on pixels of the entire original image. In the first ε process, the imaging apparatus 1 performs the smoothing process using the ε filter for a Y component in YUV. In this way, skin color correction can be performed by smoothing the luminance component in the original image.

### <A3: Second ε Process (Gradation Protection)>

Next, the imaging apparatus 1 performs a second ε process on an image after the first ε process. In the second ε process, the imaging apparatus 1 performs a smoothing process using an ε filter for a UV component in YUV. A predetermined filter coefficient is set for the ε filter used in the second ε process. Specifically, in the used ε filter, the filter coefficient is set so that an influence of a UV value of a surrounding pixel is reduced (or the influence of the UV value of surrounding pixel is ignored) for a center pixel whose UV value is lower by a predetermined value than a pixel value of the surrounding pixel (first pixel) (that is, a second pixel which is a pixel whose saturation is lower than that of the surrounding pixel).

In this way, color unevenness in the entire image can be corrected, and correction for the UV value can be reduced for the center pixel whose UV value is lower than the pixel value of the surrounding pixel by a predetermined value. In this way, since gradation protection can be performed on a region including the center pixel whose UV value is lower than the pixel value of the surrounding pixel by the predetermined value, an original clear skin can be expressed.

### <A4: Skin Map Creation>

Meanwhile, the imaging apparatus 1 creates a skin map necessary for performing “A5: makeup mask” described later. This skin map creation may be performed after or prior to “A2: first ε process” and “A3: second ε process” described above. Alternatively, the skin map creation may be performed in parallel by performing time-sharing processing by an arithmetic processing unit or parallel processing by a plurality of arithmetic processing units.

An example of the skin map is illustrated in FIG. 3. A skin map GA4 is a map in which a transparency of each pixel is set when images are synthesized. When it is presumed that a first image and a second image are synthesized, the first image is synthesized with the second image using a transparency in each pixel. For example, synthesis is performed by exchanging the first image and the second image using the transparency in each pixel.

This transparency may be set to zero. In this case, for a pixel whose transparency is set to zero, the first image is not synthesized with the second image. That is, in this case, the skin map functions to mask the first image. In the skin map in the figure, a pixel having a high transparency is represented by white, a pixel having zero transparency is represented by black, and an intermediate transparency is indicated by hatching.

A shape of the skin map GA4 is created, for example, in a shape corresponding to a periphery of a predetermined organ of the face included in an image to be synthesized. For example, a feature point or contour of the predetermined organ in the image is detected by image analysis, and a shape based on a detection result is created. Further, a transparency is set so that a pixel having a higher saturation than that of a surrounding pixel has a higher transparency. A range set as the periphery may be determined in advance according to a type of the detected predetermined organ. For example, when the detected predetermined organ is an eye, an upper outer side of an eye area to which makeup is frequently applied may be determined as the periphery. In addition, when the detected predetermined organ is a lip, the entire lip to which makeup is frequently applied may be determined as the periphery.

For example, as illustrated in FIG. 3, when the eye of the user is included in the image to be synthesized, the elliptical skin map GA4 corresponding to the upper outer side of the periphery of the eye (that is, the eye area) is created. In this example, by makeup, the transparency is set higher at a center of the eye area where the saturation is higher than that of the surrounding pixel, and the transparency is set lower at the outside of the eye area.

The shape of the skin map GA4 may be newly generated each time processing is performed, or may be created using a template. In this case, a template representing peripheralness of the predetermined organ of the face is stored according to each predetermined organ. Then, this template is adapted to a size and an orientation of the predetermined organ in the image. For example, the feature point or contour of the predetermined organ in the image is detected by image analysis, and the template is adapted by enlarging, reducing, rotating, etc. based on a detection result.

In this case, the transparency in the template may be determined in advance. For example, the transparency may be determined such that the transparency is set higher at a center of the predetermined organ, and the transparency is set lower at the outside of the predetermined organ. Alternatively, the transparency may be determined such that the transparency is set based on a predetermined condition according to a type of each predetermined organ. In this way, the skin map GA4 can be created.

### <A5: Makeup Mask (Restoration)>

Next, the imaging apparatus 1 synthesizes the original image GA1 before the first ε process and the second ε process and the image GA3 after the second ε process based on the transparency of the skin map GA4. For example, synthesis is performed by exchanging a UV component of the original image and a UV component of an image after the second ε process using a transparency in each pixel. An image created by this synthesis is a last image in the skin image correction process.

Here, as described above, in the skin map GA4, the transparency is set so that a pixel having a higher saturation than that of a surrounding pixel has a higher transparency. For this reason, the unsmoothed original image GA1 is synthesized at a higher rate with respect to a pixel to which makeup has been applied (that is, pixel having a higher saturation than that of the surrounding pixel). That is, correction for the pixel to which makeup has been applied is reduced. In this way, the effect by makeup can be maintained.

The above-described “A4: skin map creation” and this makeup mask may be performed on the entire original image GA1. However, in this case, processing is performed for all pixels in the original image GA1 including a region that is not targeted for reduction of correction. Therefore, the processing amount in arithmetic processing increases. Therefore, “A4: skin map creation” and this makeup mask may be performed for each detected predetermined organ. In this case, the skin map GA4 is created with a predetermined size including the detected predetermined organ. Further, the original image GA1 and the image GA3 after the second ε process are cut out with this predetermined size. Then, the cut-out images are synthesized, and a last image (a predetermined size corresponding to cut-out) after synthesis is exchanged with a corresponding portion of the image GA3 (the entire image) after the second ε process. Then, this process is performed for each of the detected predetermined organ. For example, this process is performed for each of the detected right eye, left eye, and mouth. In this way, only for the predetermined size, “A4: skin map creation” and the makeup mask may be performed. For this reason, a processing amount as a whole can be reduced and processing can be completed at a higher speed.

### <A6: Last Image Output>

Finally, the imaging apparatus 1 outputs a last image GA6 created by “A5: makeup mask”. The last image GA6 is an image in which an effect of makeup and an expression of an original clear skin are retained by correcting an expression of texture of the skin by smoothing with respect to YUV components in each of “A2: first ε process” and “A3: second ε process” and reducing correction according to saturation in “A3: second ε process” and “A5: makeup mask”. That is, by performing the skin image correction process as described above, more appropriate correction can be performed in image processing for an image including skin.

### [Functional Configuration]

FIG. 4 is a functional block diagram illustrating a functional configuration for executing the above-described skin image correction process in a functional configuration of the imaging apparatus 1 of FIG. 1.

In the case of executing the skin image correction process, as illustrated in FIG. 4, in the CPU 11, an image acquisition unit 111, a face detection unit 112, a correction execution unit 113, a reduction pixel specification unit 114, a correction control unit 115, and a synthesis unit 116 function.

In addition, an image storage unit 191 and a skin map storage unit 192 are set in one region of the storage unit 19. Data necessary for realizing the skin image correction process is appropriately transmitted and received at appropriate timing between these functional blocks, even when not specifically mentioned below.

An image output from the imaging unit 16 is stored in the image storage unit 191. In addition, the image storage unit 191 stores an image after the first ε process, an image after the second ε process, and a last image created in the skin image correction process.

The skin map storage unit 192 stores the skin map created in the skin image correction process. As described above, when a skin map is created using a template, the skin map storage unit 192 stores this template.

The image acquisition unit 111 acquires an image captured by the imaging unit 16 and subjected to development processing, or an image to be processed from the image storage unit 191. This image corresponds to the original image described above.

The face detection unit 112 detects a face from the image acquired by the image acquisition unit 111 and detects each organ included in the face in the detected face. For face detection and detection of each organ, it is possible to use an existing face detection technology and an existing organ technology.

The correction execution unit 113 performs a correction process of smoothing the image acquired by the image acquisition unit 111. That is, the correction execution unit 113 performs the first ε process and the second ε process described above. The first ε process and the second ε process by the correction execution unit 113 are performed based on the control of the correction control unit 115 described later.

The reduction pixel specification unit 114 specifies a pixel for which correction is reduced based on the detection result of the face detection unit 112. That is, the reduction pixel specification unit 114 specifies a pixel whose saturation is lower than that of a surrounding pixel and a pixel whose saturation is higher than that of a surrounding pixel.

The correction control unit 115 controls the correction process executed by the correction execution unit 113 based on the detection results of the image acquisition unit 111 and the reduction pixel specification unit 114. That is, the correction control unit 115 controls the first ε process and the second ε process performed by the correction execution unit 113. In addition, the correction control unit 115 creates a skin map for controlling a restoration process.

The synthesis unit 116 performs the restoration process described above. This restoration process is performed based on the skin map created by the correction control unit 115. In addition, the synthesis unit 116 outputs a last image created by the restoration process. For example, the synthesis unit 116 outputs the last image to store the last image in the image storage unit 191 or display the last image on the output unit 18.

### [Operation]

FIG. 5 is a flowchart for description of a flow of the skin image correction process executed by the imaging apparatus 1 of FIG. 1 having the functional configuration of FIG. 4. The skin image correction process is started by an operation of starting the skin image correction process to the input unit 17 by the user. The operation of starting the skin image correction process may correspond to an image capturing instruction operation, and the skin image correction process may be continuously performed on an image captured by the imaging unit 16 according to the image capturing instruction operation and subjected to development processing. Alternatively, the operation of starting the skin image correction process may correspond to an operation of selecting an image stored in the image storage unit 191 and starting the skin image correction process for the selected image.

First, the image acquisition unit 111 acquires, as an original image, an image captured by the imaging unit 16 and subjected to development processing or an image to be processed from the image storage unit 191 (step S11). This step S11 corresponds to “Al: acquisition of original image” described above.

The correction execution unit 113 performs the first ε filter process on the Y component of the original image based on control of the correction control unit 115 (step S12). This step S12 corresponds to the “A2: first ε process” described above.

The face detection unit 112 performs face detection in the image subjected to the first ε filter process, and determines whether a face has been detected (step S13). When the face has not been detected (No in step S13), the skin image correction process ends. In this way, the image subjected to the first ε filter process is created. On the other hand, when the face has been detected (Yes in step S13), the process proceeds to step S14.

The face detection unit 112 detects an organ in the face detected in step S13 (step S14).

The reduction pixel specification unit 114 specifies a pixel for which correction is reduced (step S15). That is, the reduction pixel specification unit 114 specifies a pixel whose saturation is different from that of a surrounding pixel by a predetermined pixel value level, specifically, a pixel whose saturation is lower than that of the surrounding pixel, or conversely, a pixel whose saturation is higher than that of the surrounding pixel. A pixel region for which correction is reduced may be specified after the image to be processed is input. When a position of a pixel region corresponding to a target of reduction is fixed, the pixel region at the position may be set as a pixel region for which correction is reduced in advance and stored in a predetermined storage region of the storage unit 19 in advance. Then, in step S15, the pixel for which correction is reduced may be specified by reading the stored pixel region for which correction is to be reduced.

The correction execution unit 113 performs the second ε filter process on the UV component based on control of the correction control unit 115 (step S16). This step S16 corresponds to “A3: second ε process” described above.

The correction control unit 115 creates a skin map (step S17). This step S17 corresponds to the “A4: skin map creation” described above.

The synthesis unit 116 performs image synthesis as described above with reference to FIG. 3 for any of organs detected in step S14 (step S18).

The synthesis unit 116 determines whether image synthesis has been completed for all the organs (step S19). When image synthesis has not been performed for all the organs (No in step S19), image synthesis is performed for an unprocessed organ in step S18. On the other hand, when image synthesis has been performed for all the organs (Yes in step S19), the process proceeds to step S20. Step S18 and step S19 correspond to “A5: restoration process” described above.

The synthesis unit 116 outputs the created last image (step S20). In this way, the skin image correction process ends. This step S20 corresponds to “A6: last image output” described above.

According to the skin image correction process described above, it is possible to perform more appropriate correction in image processing for an image including skin by perform a control operation to reduce the correction process for a partial region. For example, by reducing correction, it is possible to correct the expression of the texture of the skin while retaining the effect of makeup and the expression of the original clear skin. That is, it is possible to perform image processing in which such two expressions are compatible.

### [Configuration Example]

The imaging apparatus 1 configured as described above includes the correction execution unit 113, the reduction pixel specification unit 114, and the correction control unit 115. The correction execution unit 113 performs a correction process on a pixel region of a skin color in an image. The reduction pixel specification unit 114 acquires a pixel region saturation of which is different from that of a surrounding pixel in the image. The correction control unit 115 performs a control operation to reduce the correction process by the correction execution unit 113 for the pixel region acquired by the reduction pixel specification unit 114. In this way, it is possible to perform more appropriate correction in image processing for an image including skin. For example, it is possible to perform image processing that achieves the effect of makeup and compatibility between the expression of the original clear skin and the expression of the texture of the skin.

The imaging apparatus 1 further includes the face detection unit 112. The image includes a region of the face. The face detection unit 112 detects an organ present in the region of the face. The reduction pixel specification unit 114 acquires a pixel region, which has a higher saturation than that of a surrounding pixel, around the organ detected by the face detection unit 112. In this way, in the pixel region, which has a higher saturation than that of a surrounding pixel, around the organ, it is possible to prevent the effect of makeup from being lost due to lack of color by smoothing a low saturation in another pixel region. That is, more appropriate correction can be performed while retaining the effect of makeup applied to a periphery of the organ.

The organ is the eye, and the periphery of the organ is the eye area. In this way, it is possible to perform more appropriate correction while retaining the effect of makeup such as eye shadow and eye line applied to the eye area.

The organ is the mouth and the periphery of the organ is the lip. In this way, in particular, more appropriate correction can be performed while retaining the effect of makeup such as lipstick and gloss applied to the lip.

The reduction pixel specification unit 114 acquires a pixel region whose saturation is lower than that of a surrounding pixel. In this way, it is possible to protect the gradation in the pixel region whose saturation is lower than that of the surrounding pixel. Therefore, in the pixel region whose saturation is lower than that of the surrounding pixel, it is possible to prevent the clear skin from being lost due to a color by smoothing a high saturation in another pixel region.

The imaging apparatus 1 further includes the image acquisition unit 111, the image storage unit 191, and the synthesis unit 116. The image storage unit 191 holds the image input by the image acquisition unit 111. The correction execution unit 113 performs a correction process on the pixel region of the skin color in the image that is input by the image acquisition unit 111 and not stored in the image storage unit 191. The synthesis unit 116 synthesizes an image whose correction process is reduced by the correction control unit 115 and an image stored in the image storage unit 191 using a map in which the transparency of the pixel is set. In this way, it is possible to create an image that combines features of both the uncorrected image and the corrected image.

The reduction pixel specification unit 114 sets a pixel region for which the correction process is reduced in an image before the correction process by the correction execution unit 113 is performed. In this way, it is possible to eliminate the need to specify a pixel region for which the correction process is reduced each time a process for reducing the correction process is executed.

The correction control unit 115 performs a control operation to reduce the correction process by the correction execution unit 113 for an image after the correction process is performed by the correction execution unit 113. In this way, the correction process can be reduced after the correction process is performed as usual. That is, it is possible to eliminate the need for a particular correction process to reduce the correction process.

### [Modification]

The invention is not limited to the above-described embodiment, and modifications, improvements, etc. within the scope that can achieve the object of the invention are included in the invention. For example, the above-described embodiment may be modified as in the following modification.

<Modification in which Exchange is not Performed>

In the above-described embodiment, synthesis is performed by performing the smoothing process using the ε filter in “A3: second ε process”, and then performing exchange based on the skin map in which the transparency is set to be higher for a pixel having a higher saturation than that of a surrounding pixel in “A5: restoration process”. However, the invention is not limited thereto, and exchange may not be performed. In this case, in “A3: second ε process”, it is sufficient that the pixel whose saturation is higher than that of the surrounding pixel is excluded from a target of the smoothing process using the ε filter, and the smoothing process is not performed for this pixel.

<Modification with Regard to Correction Process>

In the embodiment described above, the skin color is corrected by performing the smoothing process using the ε filter in each of “A2: first ε process” and “A3: second ε process”. However, the invention is not limited thereto, and correction may be performed by another process other than the smoothing process using the ε filter as long as the process is a process for correcting the skin color in the image.

<Modification with Regard to Characteristic of User>

In the above-described embodiment, the skin image correction process is performed regardless of a characteristic of the user in the image. However, the invention is not limited thereto, and the skin image correction process may not be performed based on the characteristic of the user. For example, a functional block for detecting gender by analyzing an image may be added to the imaging apparatus 1, and the skin image correction process may not be performed in the case of detecting that the user in the image is a male since there is a low possibility of makeup.

<Modification with Regard to Target of Restoration Process>

In the embodiment described above, the skin map is created by “A4: skin map creation” for the periphery of the organ, and synthesis is performed by performing exchange for the periphery of the organ in “A5: restoration process”. However, the invention is not limited thereto, and exchange may be performed for a part other than the organ. For example, synthesis may be performed such that after exchange is performed for a periphery of an organ, a skin map is created by “A4: skin map creation” for a pixel whose saturation is higher than that of a surrounding pixel in a part other than the organ, and exchange is performed for the part in “A5: restoration process”. In this way, for example, the smoothing process can be reduced for a cheek region to which makeup is applied. Further, when this modification is combined with the above-described <modification in which exchange is not performed>, for example, the smoothing process may not be performed for the cheek region to which makeup is applied.

### <Other Modifications>

In the above-described embodiment, the imaging apparatus 1 to which the invention is applied has been described using a digital camera as an example. However, the invention is not particularly limited thereto. For example, the invention can be applied to general electronic devices having a whitening process function. Specifically, for example, the invention can be applied to a notebook personal computer, a printer, a television receiver, a video camera, a portable navigation device, a mobile phone, a smartphone, a portable game machine, etc.

The series of processes described above can be executed by hardware or can be executed by software. In other words, the functional configuration of FIG. 4 is merely an example and is not particularly limited. That is, it is sufficient that the imaging apparatus 1 has a function capable of executing the above-described series of processing as a whole, and a functional block used to realize this function is not particularly limited to the example of FIG. 4. In addition, one functional block may include hardware alone, software alone, or a combination thereof. The functional configuration in the present embodiment is realized by a processor that executes arithmetic processing, and the processor that can be used in the present embodiment is configured by units of various processing devices such as a single processor, a multiprocessor, and a multicore processor. In addition thereto, a combination of these various processing devices and a processing circuit such as an application specific integrated circuit (ASIC) or a field-programmable gate array (FPGA) is included.

When a series of processing is executed by software, a program included in the software is installed on a computer, etc. from a network or a recording medium. The computer may be a computer incorporated in dedicated hardware. Alternatively, the computer may be a computer capable of executing various functions by installing various programs, for example, a general-purpose personal computer.

The recording medium having such a program includes the removable medium 31 of FIG. 1 distributed separately from an apparatus main body to provide the program to the user, and includes a recording medium, etc. provided to the user in a state of being incorporated in the apparatus main body in advance. For example, the removable medium 31 includes a magnetic disk (including a floppy disk), an optical disc, a magneto-optical disk, etc. For example, the optical disc includes a compact disk-read only memory (CD-ROM), a digital versatile disc (DVD), a Blu-ray (registered trademark) Disc, etc. The magneto-optical disk includes a mini-disk (MD), etc. In addition, the recording medium provided to the user in the state of being incorporated in the apparatus main body in advance includes, for example, the ROM 12 of FIG. 1 in which the program is recorded, the hard disk included in the storage unit 19 of FIG. 1, etc.

In this specification, a step for describing a program recorded on a recording medium naturally includes a process performed in time series in order and includes a process executed in parallel or individually even when the process may not be processed in time series.

As mentioned above, even though several embodiments of the invention have been described, these embodiments are merely illustrative and do not limit the technical scope of the invention. The invention can take other various embodiments, and various modifications such as omission and replacement can be made without departing from a gist of the invention. These embodiments and modifications thereof are included in the scope or gist of the invention described in this specification, etc. and included in the invention described in the claims and an equivalent scope thereof.

What is claimed is:

1. An image processing apparatus comprising a processor,
wherein the processor
acquires a pixel region of a first pixel and a pixel region of a second pixel whose saturation is higher than a saturation of the first pixel in an image region of a skin color in an image,
performs, a smoothing process on the pixel region of the skin color in the image so that an intensity of the smoothing process of the skin color luminance component of the pixel region of the second pixel is less than the intensity of the smoothing process of the skin color luminance component of the pixel region of the first pixel; and,
a memory stored the image having the smoothed pixel region.

2. The image processing apparatus according to claim 1,
wherein the processor
generates, from the image, an image before the smoothing process is performed on the image region of the skin color and an image after the smoothing process is performed on the image region of the skin color at a preset intensity, and
synthesizes the generated image before the smoothing process is performed and the generated image after the smoothing process is performed using a map prepared in advance in which a transparency is set higher for a pixel having a higher saturation as intensity information of the smoothing process.

3. The image processing apparatus according to claim 1,
wherein the image includes an image of a face,
the processor
detects an image corresponding to an organ present in the face, and
the pixel region of the second pixel is a pixel region around the detected image corresponding to the organ.

4. The image processing apparatus according to claim 3, wherein the organ is an eye, and the image region of the second pixel is a pixel region corresponding to an eye area.

5. The image processing apparatus according to claim 3, wherein the organ is a mouth, and the image region of the second pixel is a pixel region corresponding to a lip.

6. An image processing method comprising:
an acquisition step of acquiring a pixel region of a first pixel and a pixel region of a second pixel whose saturation is higher than a saturation of the first pixel in an image region of a skin color in an image;
a processing step of performing a smoothing process on the pixel region of the skin color in the image so that an intensity of the smoothing process of the skin color luminance component of the pixel region of the second pixel is less than the intensity of the smoothing process of the skin color luminance component of the pixel region of the first pixel; and,
a storing step of the image having the smoothed pixel region to a memory.

7. The image processing method according to claim 6,
wherein the processing step includes
a generation step of generating, from the image, an image before the smoothing process is performed on the image region of the skin color and an image after the smoothing process is performed on the image region of the skin color at a preset intensity, and
a synthesis step of synthesizing the generated image before the smoothing process is performed and the generated image after the smoothing process is performed using a map prepared in advance in which a transparency is set higher for a pixel having a higher saturation as intensity information of the smoothing process.

8. The image processing method according to claim 6,
wherein the image includes an image of a face,
the method further comprises a detection step of detecting an image corresponding to an organ present in the face, and
the pixel region of the second pixel is a pixel region around the image corresponding to the organ detected in the detection step.

9. The image processing method according to claim 8, wherein the organ is an eye, and the image region of the second pixel is a pixel region corresponding to an eye area.

10. The image processing method according to claim 8, wherein the organ is a mouth, and the image region of the second pixel is a pixel region corresponding to a lip.

11. A recording medium on which a program readable by a computer included in an image processing apparatus is recorded, the recording medium causing the computer to function as:
an acquisition mechanism that acquires a pixel region of a first pixel and a pixel region of a second pixel whose saturation is higher than a saturation of the first pixel in an image region of a skin color in an image;
a processing mechanism that performs, a smoothing process on the pixel region of the skin color in the image so that an intensity of the smoothing process of the skin color luminance component of the pixel region of the second pixel is less than the intensity of the smoothing process of the skin color luminance component of the pixel region of the first pixel; and,
a storing mechanism that stores to the image having the smoothed pixel region to a memory.

12. The recording medium according to claim 11, causing the computer to further function as:
a generation mechanism that generates, from the image, an image before the smoothing process is performed on the image region of the skin color and an image after the smoothing process is performed on the image region of the skin color at a preset intensity; and
a synthesis mechanism that synthesizes the generated image before the smoothing process is performed and the generated image after the smoothing process using a map prepared in advance in which a transparency is set higher for a pixel having a higher saturation as intensity information of the smoothing process.

13. The recording medium according to claim 11,
wherein the image includes an image of a face,
the computer is caused to further function as
a detection mechanism that detects an image corresponding to an organ present in the face, and
the pixel region of the second pixel is a pixel region around the detected image corresponding to the organ.

14. The recording medium according to claim 13, wherein the organ is an eye, and the image region of the second pixel is a pixel region corresponding to an eye area.

15. The recording medium according to claim 13, wherein the organ is a mouth, and the image region of the second pixel is a pixel region corresponding to a lip.
